(19) United States
(12) Patent Application Publication
(10) Pub. No.: US 2011/0303052 A1
(43) Pub. Date: Dec. 15, 2011

(54) WRENCH WITH INTERCHANGEABLE MULTI-TOOL HEADS

(76) Inventor: Steven Chen, Las Vegas, NV (US)

(21) Appl. No.: 13/158,654

(22) Filed: Jun. 13, 2011

Related U.S. Application Data
(60) Provisional application No. 61/354,501, filed on Jun. 14, 2010.

(51) Int. Cl. B25B 23/00; B25B 13/02

(52) U.S. Cl. 81/57.5; 29/426.2

(57) ABSTRACT

A wrench is configured to interchangeably accept different multi-tool heads. The wrench has tool head mounts located at opposing ends of a body. Connectors or connecting mechanisms are provided for interchangeably accepting tool heads at each mount. The connectors may comprise mounting pins which pass through a passage in the tool head and engage struts of the mounts.

### RELATED APPLICATION DATA

This application claims priority to U.S. Provisional Application Ser. No. 61/354,501, filed Jun. 14, 2010.

### FIELD OF THE INVENTION

The present invention relates to tools, and particularly to wrenches.

### BACKGROUND OF THE INVENTION

A wide variety of wrenches and similar tools are known. Various improvements have been made to these tools over time in order to improve them.

For example, box and open end wrenches have been developed in various configurations. These wrenches are generally configured to engage the head of a fastener or a mating connector such as a nut. A problem with box and open end wrenches is that each end of the wrench has a single head. In some configurations both the open and closed end of the wrench are the same size and thus configured to fit only a single sized fastener or connector. At most, the two ends of the wrench may be of different sizes. While this offers greater flexibility, a great number of such wrenches are still required to address the wide range of sizes of fasteners.

As one attempt to address this issue, socket wrenches were developed. These wrenches have a handle having a socket-accepting head at one end. In another solution, wrenches have been developed which have multi-tool heads fixed at one or both ends. The heads may be moved to one of various positions in order to access and utilize one portion of the tool.

Still, there remains a need for improved tools. For example, a problem with socket wrenches is that while the user is not required to have completely different tools for a wide range of fastener/connector sizes, the user must still have a large number of individual sockets for such purposes.

### SUMMARY OF THE INVENTION

One aspect of the invention is a wrench which is configured to interchangeably accept different multi-tool heads.

In one embodiment the wrench comprises a body having a first end, an opposing second end and an intermediate or central grip. A first tool mount is located at the first end of the body and a second tool mount is located at the second end of the body.

The wrench includes at least one connector or connecting mechanism for interchangeably connecting different tool heads to each mount. In one embodiment each mount is generally “U” shaped, having a pair of struts separated from one another by a recess. The struts are configured to accepting a mounting pin. The mounting pin is configured to mount to (such as by passing through a passage in) each strut and a portion of a tool head located between the struts.

Each mounting pin is removable from its mount, thus permitting an associated tool head to be removed and interchanged with another tool head. Each mounting pin may include a locking member for retaining it in position when a tool head is in use.

Each tool head preferably defines multiple tools. In one embodiment each tool head defines a passage for accepting a mounting pin. A variety of tools are mounted on or defined by the tool head. Such tools may comprise sockets, drive pins, Allen wrenches, screwdrivers and/or a wide variety of other tools or combinations of such tools.

In use, a user may locate a multi-tool head at both mounts of the wrench. In this manner, the wrench defines a plurality of tools as part of a single wrench. More advantageously, the tool heads may be interchanged, thus permitting the user to change the configuration of the wrench by associating other multi-tool heads with the wrench.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a wrench with interchangeable multi-tool heads;

FIG. 2 is a cross-sectional perspective view of a mounting pin mounted to a mount of the wrench illustrated in FIG. 1 taken along line 2-2 therein;

FIG. 3 is a perspective view of a first multi-tool head; and

FIG. 4 is a perspective view of a second multi-tool head, the head having at least one socket configured to accept a light element.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a wrench which is configured to interchangeability accept two or more different tool heads. In a preferred embodiment, the wrench is configured to accept two tool heads at opposing ends of the wrench. The tool heads preferably define multiple tools.

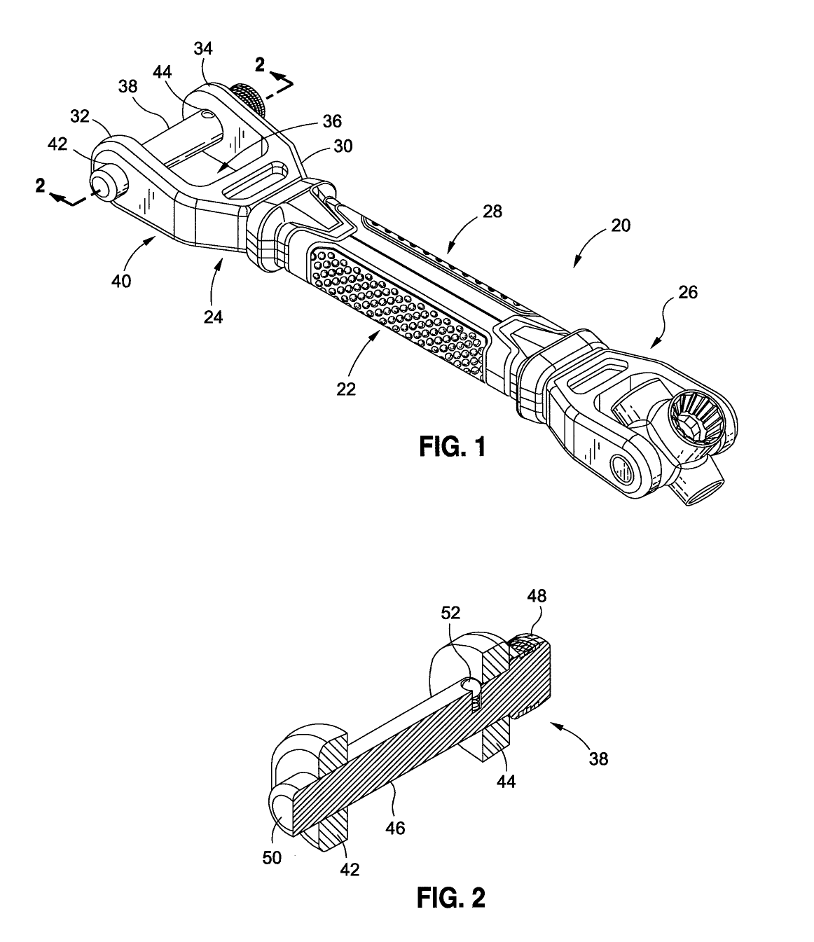

FIG. 1 illustrates a wrench 20 in accordance with the present invention. The wrench 20 has a body 22 having a first end 24, a second end 26 and a center section 28 (also referred to herein as a handle or grip). In one embodiment the body 22 is generally elongate relative to a cross-sectional dimension thereof. The body 22 may have various shapes. For example, the cross-sectional shape of the center section 28 of the body 22 may vary (including by varying along its length). As illustrated, the center section 28 of the body 22 is generally rectangular in cross-sectional shape, but it might be generally square, round, oval or the like. As detailed below, the center section 28 of the body 22 is preferably used as a handle and thus the shape and size of the body 22 are preferably selected so that the body 22 is easily and comfortably gripped.

The first and second ends 24,26 are preferably located at opposing ends of the body 22, and thus at opposite ends of the center section 28. In one embodiment, the center section 28 of the body 22 is generally straight, whereby the first and second ends 24,26 are in alignment. In other embodiments the center section 28 might be curved or have an enlarged handle member or other configuration.

At least one of the ends of the wrench 20, and preferably both ends, are configured to interchangeably accept multi-tool heads. To this end, the first and second ends 24,26 of the body 22 are each preferably configured as or to include a tool head mount 40.

In one embodiment, each mount 40 is generally “U”-shaped. Each mount 40 comprises a base portion 30. The base portion 30 is preferably connected to or comprises a portion of the body 22. Each mount 40 preferably includes first and second struts or legs 32,34 which extend outwardly from the base portion 30. As illustrated, the struts 32,34 extend outwardly generally parallel to a length of the body 22 of the wrench 20. The first and second struts 32,34 are preferably separated from one another, thus defining a tool-head accepting recess 36 there between.

As indicated, in a preferred embodiment, the wrench 20 is configured to interchangeably accept different tool heads. In a preferred embodiment, the wrench 20 is configured to interchangeably accept different tool heads at both ends thereof. By the term “interchangeably” it is meant that a first tool head may be connected to the wrench 20 and that first tool head may be disconnected or removed from the wrench and a second tool head may instead be connected or mounted to the wrench.

The wrench 20 thus includes means for detachably or interchangeably connecting at least one tool head. This means may comprise a variety of mechanisms or configurations. In a preferred configuration, tool heads are configured to be mounted to the wrench 20 via one or more connectors or connecting members/mechanisms. In one embodiment, such a connector may comprise a mounting pin 38. The mounting pin 38 is configured to be connected to and supported by one of the mounts 40.

As illustrated, each mount 40 is configured to accept and support a mounting pin 38 in a manner permitting the mounting pin to be moved and/or removed when a tool head is to be interchanged, and in a manner supporting the mounting pin and thus a tool head connected thereto when a tool head is in use. In one embodiment, both legs 32,34 of each mount 40 define shaft accepting aperture 42,44 through which a mounting pin 38 may be extended.

FIG. 2 illustrates one embodiment of a mounting pin 38 in greater detail. As illustrated, the mounting pin 38 has a body 46. Preferably, the mounting pin 38 includes a head 48. The head 48 may be mounted to or located at a first end of the body 46. In one embodiment the body 46 is generally uniform in size, such as being a rod of generally uniform circular cross-section. This permits the body 46 to pass through the apertures 42,44 of the legs 32,34 of the mount 40. The head 48 may be of various configurations, but preferably has at least one dimension that prevents the head 48 from passing through the apertures 42,44. As illustrated, the head 48 may be generally circular in cross-section and may have a knurled exterior for gripping.

In one embodiment, the mounting pin 38 has a second or free end 50 opposite the head 48. As illustrated, a user may extend the free end 50 of the mounting pin 38 through the apertures 42,44 until the head 48 prevents further insertion. At that time, the body 46 of the mounting pin 38 spans the recess 36 between the two legs or struts 42,44 of the mount 40.

Means may be provided for securing the mounting pin 40 in this mounting position. As illustrated, a ball or other lock 52 may be located in an aperture in the body 46. The ball 52 is preferably biased outwardly, such as by a spring or other biasing member, to a position in which at least a portion of the ball 52 protrudes from the body 46. The ball 52 then interferes with one of the legs 42,44 of the mount 40 to maintain the mounting pin 38 in position. Preferably, when sufficient pressure is applied to the ball 52, the ball moves inwardly against the biasing member, permitting the mounting pin 38 to be removed from the mount 40.

Of course, the mounting pin 38 might be secured by other mechanisms, such as by threadably engaging the mount 40, by a key/pin which may be passed through a passage through the mounting pin 38 or by other locking or securing members.

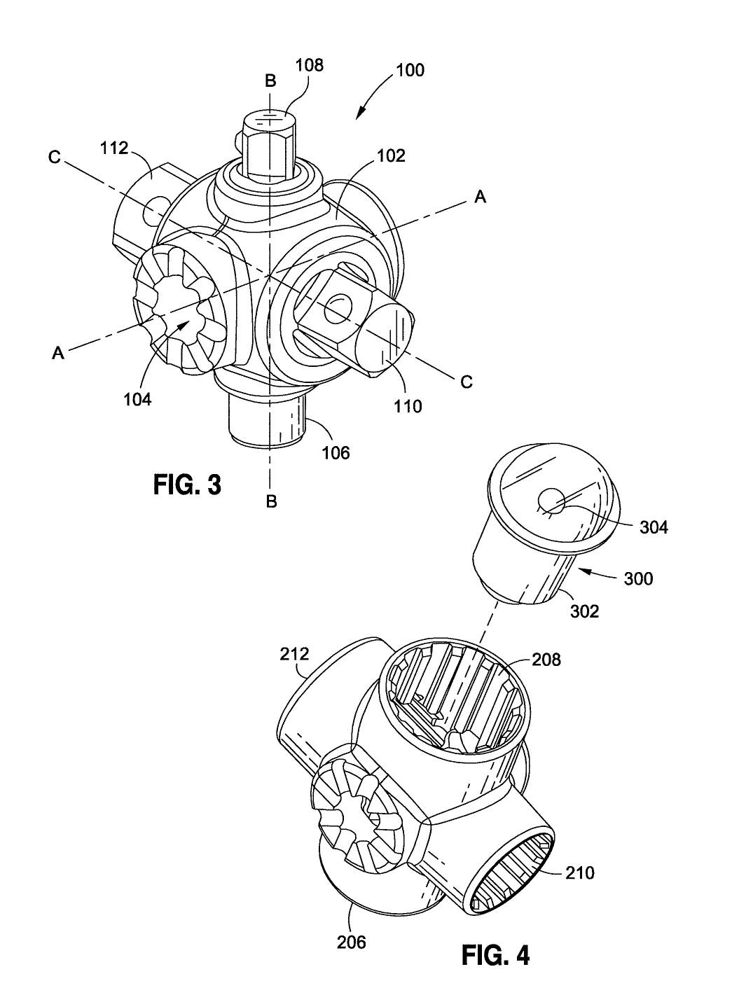

As indicated above, in a preferred embodiment the wrench 20 is configured to accept different tool heads. FIGS. 3 and 4 illustrate two different examples of tool heads.

Referring to FIG. 3, in one embodiment a tool head 100 comprises a body 102. In order to mount the tool head 100, a passage 104 is defined through the body 102. The passage 104 is designed to accept a mounting pin. As illustrated, this passage 104 may extend along a line A-A.

Preferably, the tool head 100 defines one or more tools. As illustrated in FIG. 3, the tools may comprise socket pins 106,108,110 and 112. In this configuration, the tool head 100 is generally cubic or six-sided. In one embodiment, first and second socket pins 106,108 are located at opposing sides of the tool head 100, such as along a line B-B through the head 100 (the line B-B preferably extending perpendicular to the line A-A). Third and fourth socket pins 110,112 are located at opposing sides of the tool head 100, such as along a line C-C through the head 100 (the line C-C preferably extending perpendicular to the lines A-A and B-B).

The socket pins 106,108,110,112 might have a variety of configurations. For example, one socket might comprise a ¼ inch drive pin, another might comprise a ⅜ inch drive pin, another might comprise a ½ inch drive pin, and the last one might comprise a ¾ inch drive pin. Such pins may be configured similar to those of standard socket wrenches, being configured to interchangeably receive a number of different sockets.

Another embodiment of a tool head 200 is illustrated in FIG. 4. This tool head 200 is similar to that illustrated in FIG. 3 except that in this embodiment the tool head 200 defines a plurality of sockets 206,208,210, and 212. The sockets 206,208,210,212 may be of different sizes for accepting different sized fasteners/connectors.

It will be appreciated that the tool heads 100,200 might have a variety of configurations. For example, the tool heads might support a greater or lesser number of tools than four (4). For example, a tool head might support less than four (4) tools, but preferably support two (2) or more. A tool head might support five (5) or more tools.

The particular tools which are defined or supported by each tool head may vary. Such tools might comprise socket drive pins, sockets, Allen wrenches, Phillips or flathead screwdrivers, a wide variety of other tools now know or later developed, and various combinations of such tools.

As one aspect of the invention, referring to FIG. 4, the tool head 200 might be configured to accept a light element 300. Such a light element 300 might have a base body 302 which is configured to fit within one of the sockets 208. When the socket 208 is a generally cylindrical recess, the base body 302 preferably has a similar mating cylindrical shape.

The base body 302 might define an interior space housing a power source and various electronics, such as a power switch. The power source is configured to power at least one light element 304. The light element 304 is preferably at a top end of the base body 302 so as to face or project light outwardly when the base body 302 is located in a socket.

Such a light element 304 might comprise an LED, incandescent, OLED or other type of light or light(s). Various types of switches might be used to permit a user to selectively power the light element 304. Such switches might include a push-button or the light element 100 might have a movable (in/out or twist) type head which comprises such a switch.

Use of the wrench 20 will now be described with reference to FIG. 1. As illustrated therein, a tool head may be mounted at either or both ends 24,26 of the wrench 20. In order to mount a tool head to the wrench 20, a user removes the mounting pin 38 associated with one of the mounts 40. A user then locates a tool head in the recess 36 of the mount 40 with the passage of the tool head aligned with the apertures 42,44 of the mount 40. The user then presses the mounting pin 38 through the apertures 42,44 of the mount 40 and the passage through the tool head until the mounting pin 38 is secured (such as when the ball 52 passes through the strut 44 and extends outwardly on the other side thereof.

At this time, the tool head is mounted to the body 22 of the wrench 20 for use. Advantageously, the tool head defines multiple tools. The preferred tool head mounting permits the tool head to be rotated to various positions (rotating about the mounting pin 38). This permits the user to access and use multiple tools while using a single wrench. For example, relative to the wrench 20 fitted with the tool head 100 illustrated in FIG. 3, a user may utilize the wrench 20 as a ¼ inch, ⅜ inch, ½ inch or ¾ inch socket drive, depending merely on the position of the head 100.

A particular advantage of the wrench of the invention is the interchangeability of the tool heads. As indicated above, a user may associate different tool heads with the wrench 20. Thus, a user might mount two tool heads which define different sized sockets at the ends of the wrench 20, or might mount a socket drive head at one end and a socket tool head at the other, and/or change the various tool heads at various times depending upon the desire use. Because each tool head defines multiple tools, when the wrench is configured with two tool heads, the wrench thus serves as multiple tools (such as eight (8) tools when both tool heads define at least four (4) tools each).

It will be appreciated that the wrench of the invention may have various configurations and features. For example, the wrench 20, including the body 22, may be constructed of various materials. Preferably, the wrench 20 is constructed of an alloy steel. In one embodiment, as illustrated in FIG. 1, the exterior of the center section 28 of the body 22 of the wrench 20 may be knurled or the like to improve gripping. Alternatively, a grip may be located at the center section 28. Such a grip might comprise, for example, a rubber member or material mounted on or otherwise connected to the body 22.

In a preferred embodiment, the wrench 20 is configured with two mounts configured to interchangeably accept tool heads (as illustrated, one mount at each end of the tool). However, the wrench 20 could have but one such mount or could have more than two mounts. The wrench 20 might include other features such as a fixed tool mount (for example, the wrench could define a socket drive at one end and an interchangeable tool mount at the other).

As indicated, the wrench may be configured in various manners to permit the tool heads to be interchangeable. For example, the connector or connecting members might comprise pins which extend outwardly from opposing sides of a tool head, which pins are configured to mount into slots or the like of the mounts of the wrench (and be locked/retained in place).

In a preferred embodiment, the connecting member or mechanism rotatably mounts the tool heads. As indicated, in the embodiment illustrated, the tool heads may be rotated about the mounting pins. In the example just provided, the pins of the tool head might rotate within slots of the mount. However, in other embodiments, the tool heads might be configured with ratchets, ball bearing races or the like, thus permitting the tool heads to spin or rotate into multiple positions relative to the body of the tool. For example, the tool heads could have square pins which extend outwardly from opposing sides, those square pins configured to engage slots in a mount, thus locking the pins in place in a manner preventing their rotation. However, the tool-defining portion of the tool head may be configured to rotate relative to those pins, thus permitting the tool head to be moved to various positions.

In one embodiment, a locking or fixing mechanism may be provided for maintaining the tool head in a fixed position during use, but permitting it to be rotated to another position when a user wishes to use another tool.

The tool heads may thus be interchangeably mounted in various manners other than those illustrated and described herein. In one embodiment, the mounts 40 of the wrench 20 may comprise a portion of the body 22. For example, the entire body 22 including the mounts 40 may be cast or machined as a single member. However, in other embodiments the mounts 40 may be removable from the body 22. In one such embodiment, a tool head may be mounted to a mount and the mounts with associated tool heads may be interchangeably connected to the wrench 20. In this configuration, the connection member or mechanism may comprise a connector for the mount portion of the tool head.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A wrench capable of interchangeably accepting tool heads comprising:
a wrench body, said body having a first end, an opposing second end and a center gripping section between said first and second ends;
a tool mount located at one or both of said first and second ends; and
at least one connector configured to interchangeably connect a multi-tool head to said tool mount.

2. The wrench in accordance with claim 1 wherein said at least one connector comprises a mounting pin.

3. The wrench in accordance with claim 2 wherein said tool mount comprises a pair of spaced struts, each strut defining an opening, wherein said pin is configured to mount to said mount by being located in said openings.

4. The wrench in accordance with claim 1 further comprising at least two multi-tool heads, each tool head defining at least two tools.

5. The wrench in accordance with claim 1 comprising a first tool mount at said first end of said body and a second tool mount at said second end of said body and a connector corresponding to each of said first and second tool mounts.

6. The wrench in accordance with claim 1 wherein said connector comprises a mounting pin having a first end and a second end, a head located at said first end and including at least one locking member.

7. The wrench in accordance with claim 6 wherein said at least one locking member comprises a biased ball member configured to move between a position in which it is recessed in a body of said pin and a position in which at least a portion thereof protrudes from said body of said pin.

8. The wrench in accordance with claim 1 wherein said tool mount comprises a pair of struts defining a tool head accepting recess there between.

9. The wrench in accordance with claim 1 further comprising at least one multi-tool head, said head defining at least one socket configured to accept a light element.

10. The wrench in accordance with claim 9 wherein said light element has a generally cylindrical body for fitting into said socket.

11. A method of configuring a wrench comprising the steps of:
providing a wrench having a body, said body having a first end, an opposing second end and a center gripping section between said first and second ends and a tool mount located at one or both of said first and second ends;
disengaging a tool mount connector to remove a first multi-tool head from at least one of said tool mounts; and
engaging said tool mount connector with a second multi-tool head and mounting said second tool head to said tool mount.

12. The method in accordance with claim 11 wherein said step of disengaging comprises removing a mounting pin from said tool mount to disconnect said first tool head from said tool mount.

13. The method in accordance with claim 12 further comprising the step of removing said mounting pin from a passage through said first tool head.

14. The method in accordance with claim 13 wherein said engaging step comprises locating said mounting pin in a passage through said second tool head and connecting said mounting pin to said tool mount.
